(19) United States
(12) Patent Application Publication
(10) Pub. No.: US 2017/0238041 A1
(43) Pub. Date: Aug. 17, 2017

(54) CONSUMER ELECTRONIC ENTERTAINMENT AND DISPLAY SYSTEM

(71) Applicant: Christopher Alsante, Cornelius, NC (US)

(72) Inventor: Christopher Alsante, Cornelius, NC (US)

(21) Appl. No.: 15/434,403

(22) Filed: Feb. 16, 2017

Related U.S. Application Data
(60) Provisional application No. 62/296,346, filed on Feb. 17, 2016.

(51) Int. Cl. H04N 21/41; H04N 5/655; H04N 21/422; H04N 21/81; H04N 21/478; H04N 21/4788; G08C 17/02; H04N 21/436

(52) U.S. Cl. CPC H04N 21/4122; G08C 17/02; H04N 5/655; H04N 21/43615; H04N 21/8133; H04N 21/47815; H04N 21/4788; H04N 21/4222; H04N 21/42224; G08C 2201/93

(57) ABSTRACT

An electronic entertainment and display system that includes a primary audio/video display adapted for receiving audio/video digital information from a digital data source for display. At least one secondary audio/video display is provided for being positioned in viewing proximity to the primary audio display and adapted to receive and display supplemental audio and/or video digital information for simultaneous real time viewing with the primary display by a viewer. A control system is operatively connected to both the primary display and the at least one secondary audio/video display for controlling the operation of the system.

### CROSS-REFERENCE TO RELATED APPLICATION AND PRIORITY

This application claims priority from U.S. Provisional Patent Application No. 62/296,346, filed Feb. 17, 2016.

### TECHNICAL FIELD AND BACKGROUND OF THE INVENTION

This invention relates to a user-friendly consumer electronic entertainment and display system designed to enhance a viewer's existing or future primary display such as a television, monitor or other flat screen display. The invention has particular application with regard to simultaneous viewing of supplied audio/video programming such as supplied by broadcast, cable, satellite or internet streaming suppliers. Those aspects are in combination with customized supplementary audio/video programming created by or for the viewer and containing viewer-specific material. The supplementary programming material may be displayed on additional, secondary video displays positioned in a predetermined location proximate the primary display.

This invention also enhances a viewer's existing or future primary display such as a television, monitor or other flat screen display by providing the consumer the opportunity to readily and easily view multiple website and/or smart phone and tablet media. This invention takes advantage of improvements in video displays and smart phone tablet media to provide a unique home entertainment experience. This invention also takes advantage of improvements in video displays and the increasing availability of robust, high definition, high-speed internet systems capable of transmitting very large amounts of high definition digital data at high transfer rates. As used in this application, certain terms have the following meanings unless specifically stated otherwise:

Display information: an electronic media capable of being displayed on the electronic display system displays and electronic information exported to or downloaded from peripheral equipment connected to a display system control unit such as speaker, camera, microphone and video and music system.

Real time: input, which is processed at or near the time when the event occurs so that it is available virtually immediately.

Static or Statically: constant data showing no change.

Internet: the worldwide global communication network that allows wired or wirelessly-connected computers, pads, tablets, cameras, game boxes, phones and other digital devices to connect and exchange information.

### SUMMARY OF THE INVENTION

It is therefore an object of the present invention to provide an entertainment system that includes a primary display and one or more proximate secondary displays to provide an interactive, and/or static audio and/or video display of the consumer's choosing able to supply supplementary programming material.

It is another object of the invention to provide through a control unit of the electronic display system the ability to display supplementary programming material independently of the internet.

It is another object of the invention to provide through a dedicated website, supplementary programming material to the electronic displays in real time.

It is another object of the invention to provide supplementary programming material through an electronic display system control unit independently of the internet or through a dedicated website to one or more secondary electronic displays statically as stored on the control unit or from a dedicated website.

It is another object of the invention to provide, through an electronic display system control unit, the capability to receive and transmit information from the viewer to a dedicated website or to the internet.

It is another object of the invention to provide, through a control unit, the simultaneous and independent control of the media selected by the consumer to be displayed onto the commercially available displays.

It is another object of the invention for the control unit to be able to accept and incorporate the display drivers of the commercially available displays within the control unit, to allow communication of the consumer-chosen display media independently and simultaneously to each of the displays.

It is another object of the invention to communicate to the control unit the display media via the consumer's existing WI-FI and/or Bluetooth® interface.

It is another object of the invention to leverage the consumer's existing smart phone and/or tablet or other input device to communicate multiple and simultaneously active display media to the independently operating displays, as chosen by the consumer.

It is another object of the invention to provide a smart phone and/or tablet application, which can be downloaded onto the consumer's smart phone and/or tablet, to provide a diagrammatic image of the entertainment system in order to allow them to drag and drop consumer-selected internet, tablet and/or smart phone media onto the display as desired.

It is another object of the invention to provide the capability, via a smart phone and/or tablet application, to freeze the media on the consumer's displays and hold that display media on the display on the consumer-chosen display.

It is another object of the invention to allow the consumer's tablet and/or smart phone application media to be downloaded to the system control unit, to accept and store the consumer's tablet and/or smart phone application media to support the independent, simultaneous and active communication to the control unit, for export to the displays and to readily facilitate, as necessary, the consumer's selected media onto the displays.

It is another object of the invention to provide an optional home entertainment frame, which readily accepts the control system and all associated wiring.

These and other objects and advantages of the invention are achieved by providing a primary audio/video display in combination with one or more secondary audio/video displays positioned proximate the primary video display. The one or more secondary displays are adapted to display customized supplementary audio/video programming created by or for the viewer in real time to permit viewing of both primary and secondary displays simultaneously.

According to one preferred embodiment of the invention, the electronic entertainment and display system includes a primary audio/video display adapted for receiving audio and video digital information from a digital data source for display, at least one secondary video display for being positioned in viewing proximity to the primary video display and adapted to receive and display supplemental video digital information for simultaneous real time viewing with the primary display by a viewer, and a control system operatively connected to both the primary display and the at least one secondary video display for controlling the operation of the system.

According to another embodiment of the invention, the system includes a cabinet adapted for mounting the at least one secondary video display.

According to another embodiment of the invention, the system includes a plurality of secondary video displays wherein at least one of the plurality of secondary displays is adapted for being positioned above the primary audio/video display.

According to another embodiment of the invention, the system includes a plurality of secondary video displays wherein at least one of the plurality of secondary displays is adapted for being positioned above or below the primary audio/video display and wherein at least one of the secondary video displays is adapted for being positioned to one side of the primary audio/video display. The control system includes a receiver unit operatively associated with the at least one secondary video display for displaying received video transmissions and a wireless user-controllable transmitter unit for transmitting video data instructions to the receiver unit for displaying video data on the at least one secondary video display.

According to another embodiment, input devices such as netbooks, touchscreen personal computers and interactive whiteboards, such as the Microsoft® Surface® and conventional and touchscreen laptops are provided and are illustrative of the types of devices that are usable via a wireless protocol to access and control remote devices.

According to another embodiment of the invention, the plurality of secondary video display units include audio transmission units for providing audio, and the user-controllable transmitter unit includes a transmitter for wirelessly transmitting audio data to the secondary video display units.

According to another embodiment of the invention, the control unit is adapted to receive wireless video and audio data from an internet-enabled wireless input device.

According to another embodiment of the invention, the input device is a smartphone-type input device that includes a touch display screen.

According to another embodiment of the invention, the display screen includes a diagrammatic representation of the at least one secondary video display and is adapted for displaying a visual representation of video data to be displayed on the at least one secondary video display.

According to another embodiment of the invention, an electronic entertainment and display system is provided that includes a primary audio/video display adapted for receiving audio and video digital information from a digital data source for display and a plurality of secondary video displays wherein at least one of the plurality of secondary displays is adapted for being positioned above the primary audio/video display. At least one of the secondary video displays is adapted for being positioned to one side of the primary audio/video display for being positioned in viewing proximity to the primary video display and adapted to receive and display supplemental video digital information for simultaneous real time viewing with the primary display by a viewer. A control system is operatively connected to both the primary display and the at least one secondary video display for controlling the operation of the system, and includes a receiver unit operatively associated with the at least one secondary video display for displaying received video transmissions and a wireless user-controllable transmitter unit for transmitting video data instructions to the receiver unit for displaying video data on the at least one secondary video display. The control unit is adapted to receive wireless video and audio data from an internet-enabled wireless input device.

According to another embodiment of the invention, the plurality of secondary video display units include audio transmission units for providing audio, and the user-controllable transmitter unit includes a transmitter for wirelessly transmitting audio data to the secondary video display units.

According to another embodiment of the invention, the input device is a smart phone-type input device that includes a touch display screen.

### BRIEF DESCRIPTION OF THE DRAWING FIGURES

The present invention is best understood when the following detailed description of the invention is read with reference to the accompanying drawings, in which:

FIG. 1 is a schematic representation of a consumer electronic entertainment and display system according to one embodiment of the present invention with four secondary displays;

FIG. 2 is another schematic representation of a consumer electronic entertainment and display system according to an embodiment having three secondary displays;

FIG. 3 is a schematic representation of a consumer electronic entertainment and display system according to an embodiment where there are three secondary displays spaced apart from a centrally positioned primary display;

FIG. 4 is a schematic representation of a consumer electronic entertainment and display system according to an embodiment where there is a single secondary display positioned above a centrally-positioned primary display in combination with other home entertainment components;

FIG. 5 is a schematic representation of a consumer electronic entertainment and display system according to an embodiment where there is a single secondary display positioned above a centrally-positioned primary display;

FIG. 6 is a schematic representation of a consumer electronic entertainment and display system according to an embodiment where there are four secondary displays positioned around a centrally-positioned primary display and including other home entertainment components positioned between the secondary displays and the centrally-positioned primary display; and

FIG. 7 represents a representation of the physical layout of one preferred embodiment of the invention, showing wireless control via two of several wireless protocols.

### DETAILED DESCRIPTION OF THE PREFERRED EMBODIMENT

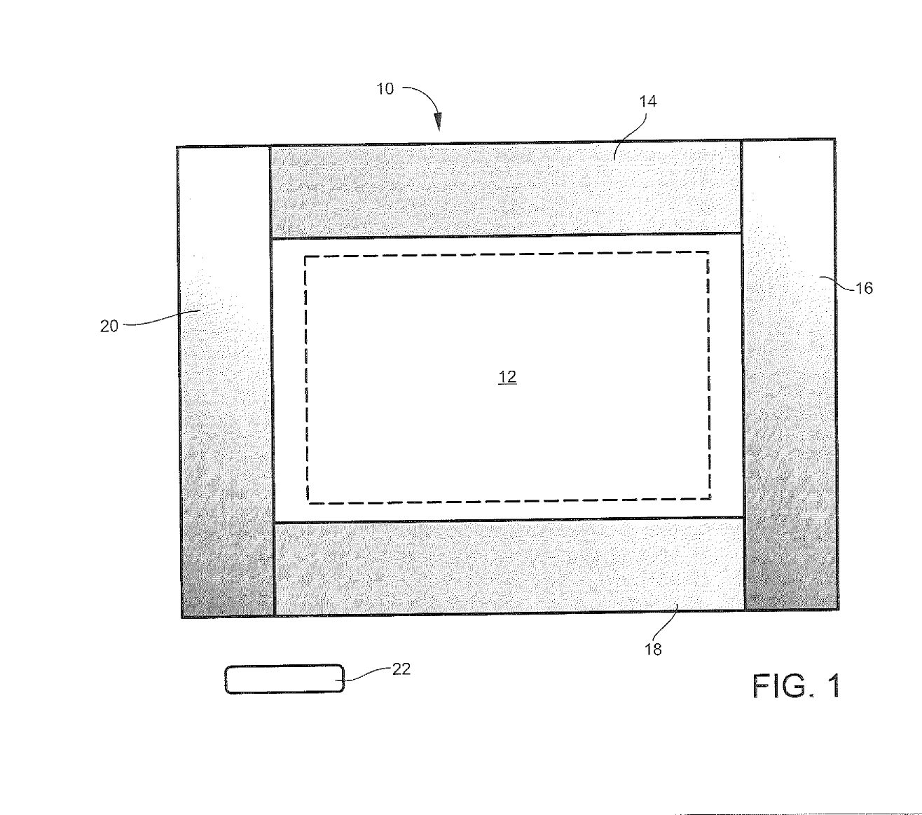

Referring now to FIG. 1 of the drawings, a consumer electronic entertainment and display system according to one illustrative embodiment of the invention is shown at reference numeral 10 and includes a primary audio/video display 12, such as a plasma or LED technology-based unit, which may be user-supplied or provided as part of the system. The system 10 includes four (4) secondary displays 14, 16, 18 and 20 that are positioned around the periphery of the primary display 12. The secondary displays 14, 16, 18 and 20 may be placed directly against the sides of the primary display 12 or, as shown, positioned in spaced-part relation on a wall or on a support such as an entertainment center. A control system 22 is electronically connected to both the primary display 12 and the secondary displays 14, 16, 18 and 20 and controls the operation of the entire system, or only selected components. In a typical arrangement, the primary display 12 would provide audio/video by means of an interface such as an HDMI connection to a cable system, broadcast station, satellite feed or internet streaming feed such as Netflix®.

The secondary displays 14, 16, 18 and 20 may be used to provide any desired supplemental display information, which may be of the same type as being fed to the primary display or may be information transmitted from an internet or other digital data source, or a static data source such as read-only or random access memory, flash drives, CD's, DVD's or other sources, presently known or unknown.

The primary display information and the supplemental display information may be interactive with each other. For example, when the primary display 12 is showing an advertisement, the supplemental display information may be order information with the ability to order through on or more of the secondary displays 14, 16, 18 and 20 the product or service being advertised on the primary display. For another example, if the primary display 12 is showing an automobile race, one or more of the secondary displays 14, 16, 18 and 20 may be providing information about the race participants, including interviews, racing statistics and history, in-car video or any other related information. The system has particular utility as a video gaming device and as a way of providing visually appealing static images on the secondary displays 14, 16, 18 and 20 that complement the active display of the primary display 12.

Similarly, a viewer can be watching entertainment on the primary display 12 why carrying on an audio/video conversation via Skype® or some other similar system. Multiple secondary displays facilitate several simultaneous secondary displays as, for example, conversations with multiple individuals via the internet.

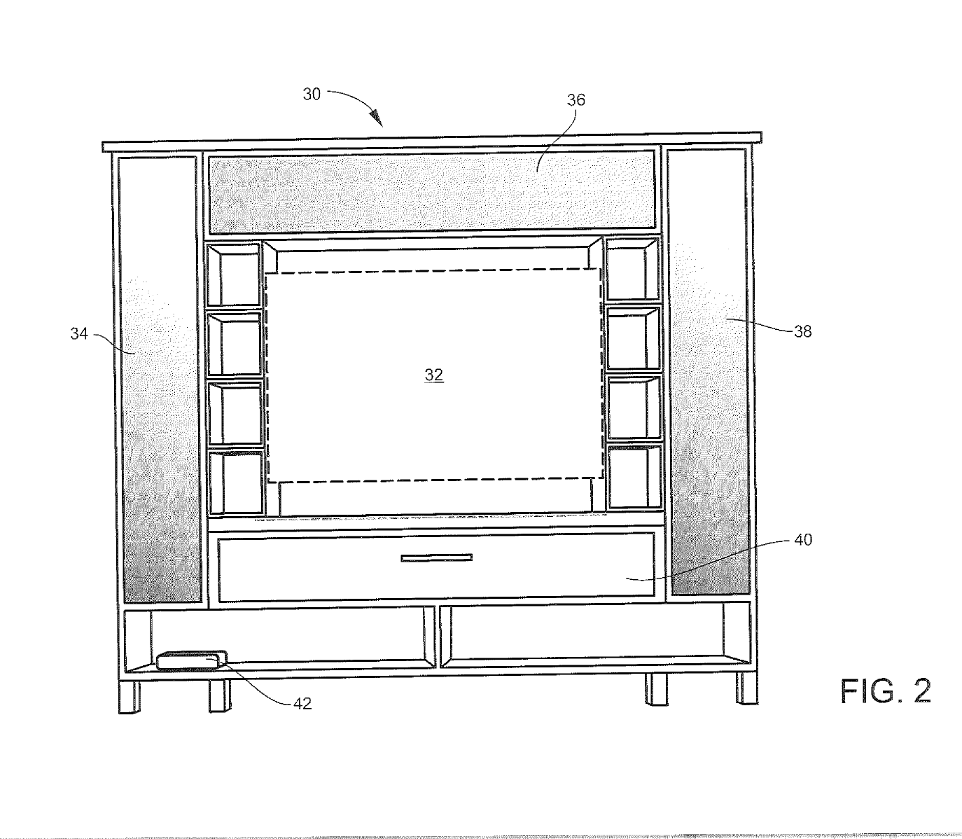

FIG. 2 shows a consumer electronic entertainment and display system according to another illustrative embodiment of the invention at reference numeral 30 and includes a primary display 32 and three (3) secondary displays 34, 36 and 38. The system 30 is installed in a home entertainment center 40 that may include peripheral electronic devices such as sound bars, DVD, Blu-Ray and VHS players, game boxes digital recorders and the like. All or some of these systems may be controlled by a control system 42.

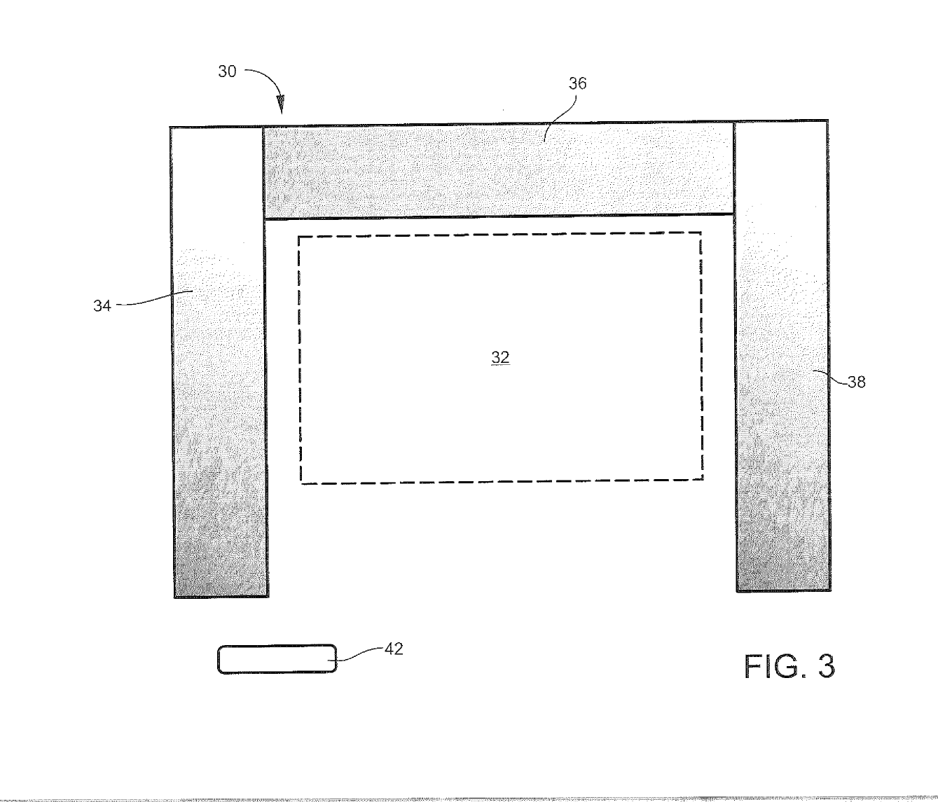

FIG. 3 shows the system 30 but as a freestanding unit or hung from a wall or other support, not shown.

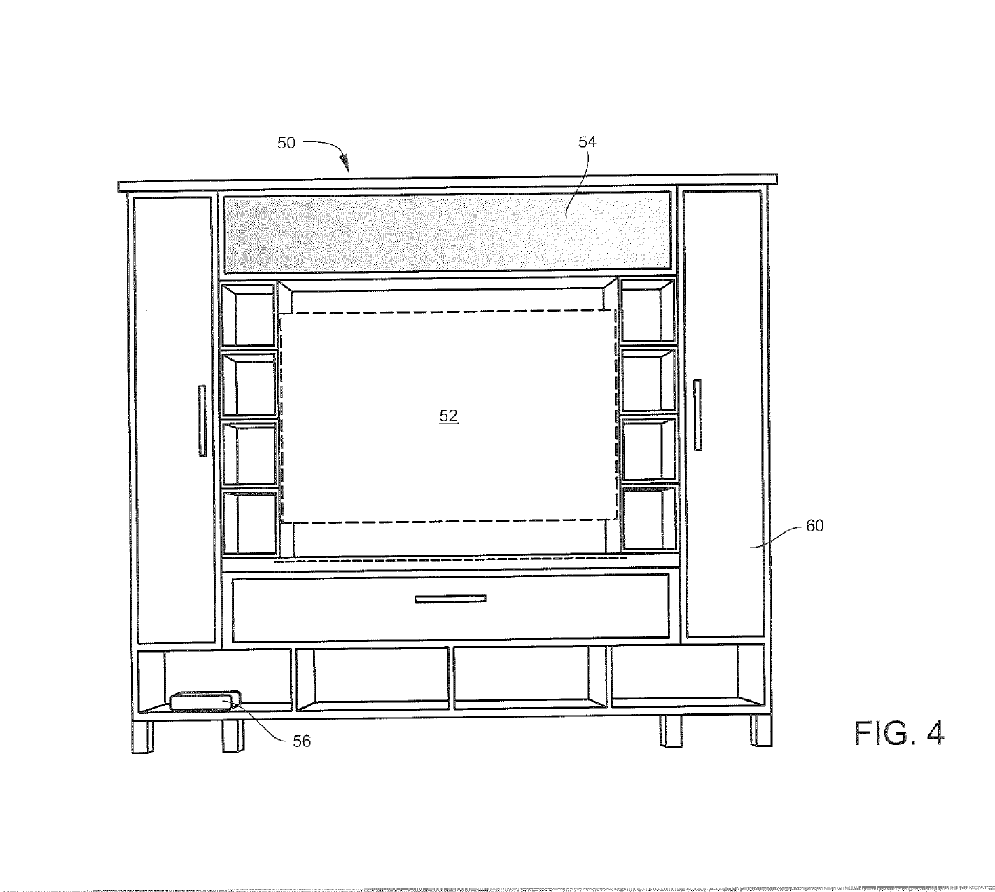

FIG. 4 shows a consumer electronic entertainment and display system according to another illustrative embodiment of the invention at reference numeral 50, and includes a primary display 52 and a single secondary display 54 positioned above the primary display 52. The system 50 is installed in a home entertainment center 60 that may include peripheral electronic devices such as sound bars, DVD, Blu-Ray and VHS players, game boxes digital recorders and the like. All or some of these systems may be controlled by a control system 56.

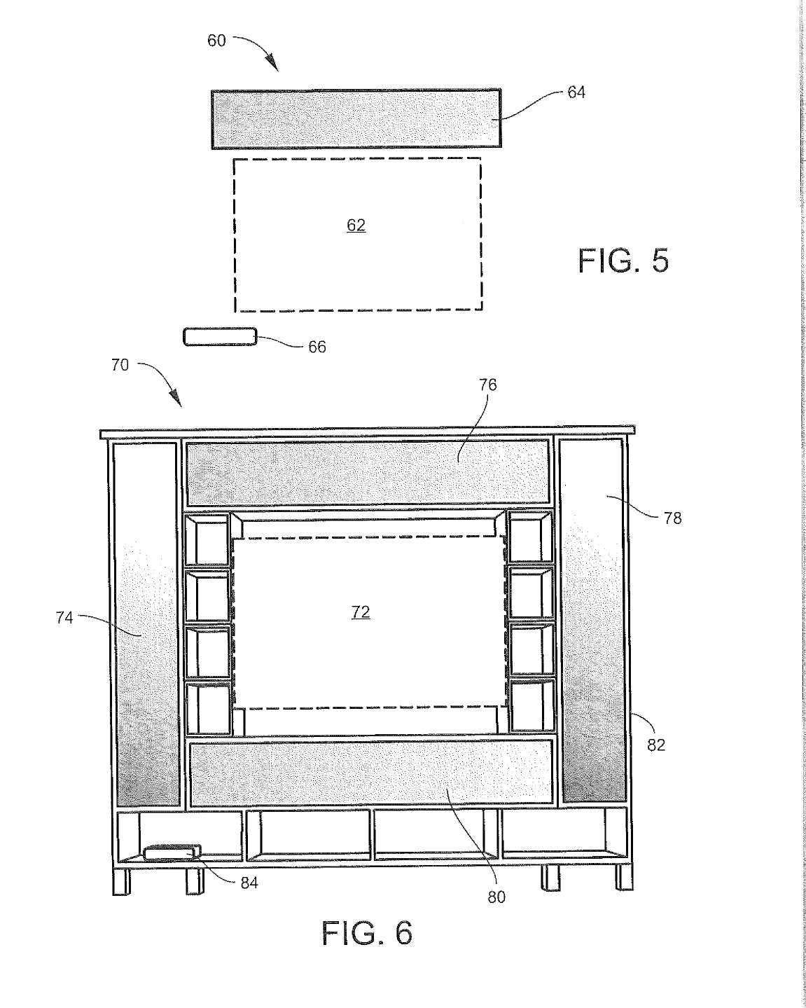

FIG. 5 shows a system 60 as a freestanding unit or hung from a wall or other support, not shown. The system 60 includes a primary display 62 over which is suspended or hung a secondary display 64. All or some of these systems may be controlled by a control system 66.

As shown in FIG. 6, a system 70 includes a primary display 72 four (4) secondary displays 74, 76, 78 and 80 that are positioned around the periphery of the primary display 72. The secondary displays 74, 76, 78 and 80 are shown positioned around the primary display 72 and an entertainment center 82. A control system 84 is electronically connected to both the primary display 72 and the secondary displays 74, 76, 78 and 80. All or some of these systems may be controlled by a control system 84.

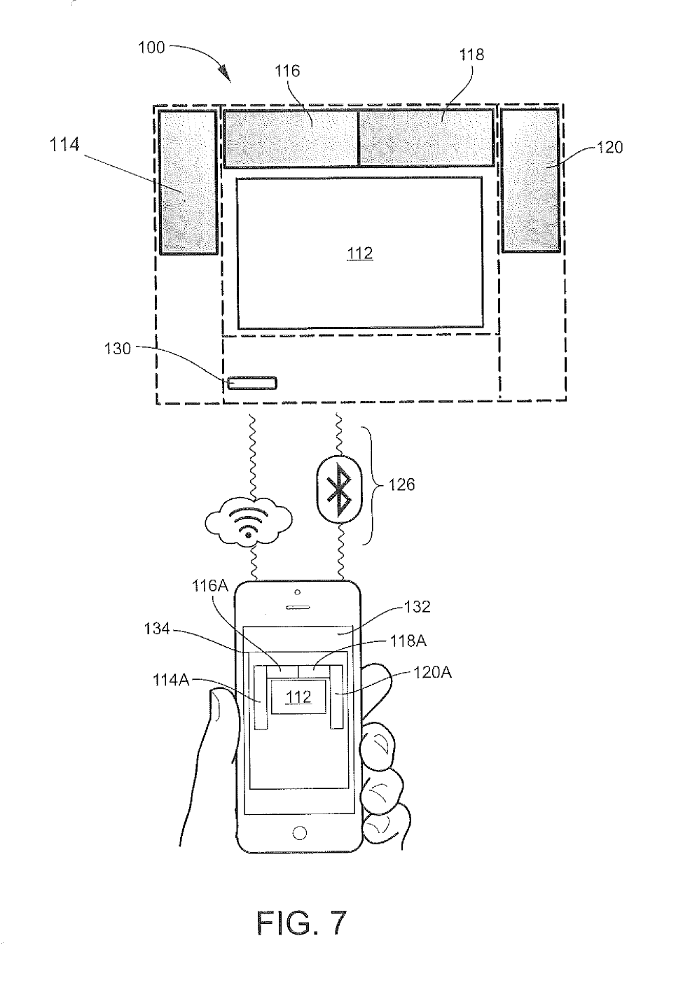

Referring now to FIG. 7, components can be used to form systems within the scope of the invention that utilize wireless hardware and software to access, download, apply and view desired active and static video data. The consumer electronic entertainment and display system 100 includes a primary audio/video display, not shown but as shown above with reference to FIGS. 1-6, such as a plasma or LED technology-based unit 112 which may be user-supplied or provided as part of the system 100. The system 100 includes a plurality of secondary display units, which may be four (4) secondary displays 114, 116, 118 and 120 that are positioned around the periphery of the primary display 112. A control system 130 is electronically connected to both the primary display 112 and the secondary displays 114, 116, 118 and 120 and controls the operation of the entire system or only selected components.

In a typical arrangement, the primary display 112 provides audio/video by means of an interface such as an HDMI connection to a cable system, broadcast station, satellite feed or internet streaming feed such as Netflix®.

The control unit 130 accepts media content selected by the consumer's smartphone or tablet input device 132, via an interface incorporated into the control unit 130. By “smartphone” or “tablet” is meant an internet-enabled wireless electronic device that includes touch-activated displays and the ability to download and use an in-device application 134, including third party applications, to access and control remote applications. As presently used, devices such as Apple iPhone®, iPod® and Samsung Galaxy® devices are illustrative of the type of device that is usable via a wireless protocol to access and control remote devices. The terms “smart phone” and “tablet” also means future developments that may vary or broaden the capabilities of these input devices as currently enabled.

In addition, other input devices such as netbooks, touchscreen personal computers and interactive whiteboards, such as the Microsoft® Surface® and conventional and touchscreen laptops are within the definition of input devices that are illustrative of the types of devices that are usable via a wireless protocol to access and control remote devices and are within the intended scope of the invention.

As presently enabled, the control unit 130 is accessed by the consumer's existing WI-FI application and/or Bluetooth® interface 136 via the input device 132, the video media is sized appropriately via resident display drivers of the display units 114, 116, 118 and 120 and the media is downloaded onto these displays 114, 116, 118 and 120 as selected by the consumer. Alternatively, the display system 100 can include access devices customized to the display system 100 rather than relying on the consumer's own internet-enabled device.

The display units 114, 116, 118 and 120 provide the maximum entertainment value to the consumer. Of course, the number of display units is consumer selectable and need not be any specific number. The display units 114, 116, 118 and 120 receive information as synchronized through the display system drivers that are resident and functioning in the control unit 130.

The display units 114, 116, 118 and 120 can receive data from the control unit 130 via a standard commercially available USB cable or other suitable connection, wired or wireless according to present or future technology and protocols.

As shown in FIG. 7, one desirable manner of controlling the selection and display of remote content on the display units 114A, 116A, 118A and 120A is to provide a diagrammatic representation of the arrangement of the display units 114, 116, 118 and 120 on the screen of the input device via the application 134. For example, the graphic representation of display unit 114 on the input device 132 may appropriately display a specific wirelessly accessed website, static image or other desired input that is transmitted via the control unit 130 to the actual display unit 114. The user may sequentially select content for as many or as few of the display units 114A, 116A, 118A and 120A via the touch screen of the input device 132 as desired that are transmitted to the actual display units 114, 116, 118 and 120. An optional timer may automatically change the displays 114, 116, 118 and 120 at user pre-selected intervals based on a queue of pre-selected active or static content. One type of suitable protocol for the control unit 130 is Real Time Streaming Protocol (RTSP), a network control protocol designed for use in entertainment and communications systems to control streaming media servers. The protocol is used for establishing and controlling media sessions between end points. Clients of media servers issue VCR-style commands, such as play, record and pause, to facilitate real-time control of the media streaming from the server to a client (Video On Demand) or from a client to the server. Other protocols, present and future, that provide the functionality described above are suitable, as well.

The display system 100 may include custom mounting racks, cabinetry, and hardware, or existing commercially available mounting equipment may be used.

A consumer electronic entertainment and display system according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. An electronic entertainment and display system, comprising:
(a) a primary audio/video display adapted for receiving audio and video digital information from a digital data source for display;
(b) at least one secondary video display for being positioned in viewing proximity to the primary video display and adapted to receive and display supplemental video digital information for simultaneous real time viewing with the primary display by a viewer; and
(c) a control system operatively connected to both the primary display and the at least one secondary video display for controlling the operation of the system.

2. An electronic entertainment and display system according to claim 1, and including a cabinet adapted for mounting the at least one secondary video display.

3. An electronic entertainment and display system according to claim 2, and including a plurality of secondary video displays wherein at least one of the plurality of secondary displays is adapted for being positioned above the primary audio/video display and wherein at least one of the secondary video displays is adapted for being positioned to one side of the primary audio/video display.

4. An electronic entertainment and display system according to claim 1, and including:
(a) a plurality of secondary video displays wherein at least one of the plurality of secondary displays is adapted for being positioned above the primary audio/video display and wherein at least one of the secondary video displays is adapted for being positioned to one side of the primary audio/video display; and
(b) the control system comprising a receiver unit operatively associated with the at least one secondary video display for displaying received video transmissions and a wireless user-controllable transmitter unit for transmitting video data instructions to the receiver unit for displaying video data on the at least one secondary video display.

5. An electronic entertainment and display system according to claim 4, wherein the plurality of secondary video display units include audio transmission units for providing audio and the user-controllable transmitter unit includes a transmitter for wirelessly transmitting audio data to the secondary video display units.

6. An electronic entertainment and display system according to claim 1, wherein the control unit is adapted to receive wireless video and audio data from an internet-enabled wireless input device.

7. An electronic entertainment and display system according to claim 6, wherein the input device is a smartphone-type input device that includes a touch display screen.

8. An electronic entertainment and display system according to claim 7, wherein the display screen includes a diagrammatic representation of the at least one secondary video display and is adapted for displaying a visual representation of video data to be displayed on the at least one secondary video display.

9. An electronic entertainment and display system, comprising:
(a) a primary audio/video display adapted for receiving audio and video digital information from a digital data source for display;
(b) a plurality of secondary video displays wherein at least one of the plurality of secondary displays is adapted for being positioned above the primary audio/video display, and wherein at least one of the secondary video displays is adapted for being positioned to one side of the primary audio/video display for being positioned in viewing proximity to the primary video display and adapted to receive and display supplemental video digital information for simultaneous real time viewing with the primary display by a viewer; and
(c) a control system operatively connected to both the primary display and the at least one secondary video display for controlling the operation of the system, the control system including a receiver unit operatively associated with the at least one secondary video display for displaying received video transmissions and a wireless user-controllable transmitter unit for transmitting video data instructions to the receiver unit for displaying video data on the at least one secondary video display, wherein the control unit is adapted to receive wireless video and audio data from an internet-enabled wireless input device.

10. An electronic entertainment and display system according to claim 9, wherein the plurality of secondary video display units include audio transmission units for providing audio, and the user-controllable transmitter unit includes a transmitter for wirelessly transmitting audio data to the secondary video display units.

11. An electronic entertainment and display system according to claim 9, wherein the input device is a smartphone-type input device that includes a touch display screen.
